(19) United States
(12) Patent Application Publication
(10) Pub. No.: US 2011/0109807 A1
(43) Pub. Date: May 12, 2011

(54) VIDEO DATA PROCESSING DEVICE AND VIDEO DATA PROCESSING METHOD

(75) Inventors: Yoko KUBO, Osaka (JP); Ai Ogata, Kyoto (JP); Masahiro Nakahira, Osaka (JP)

(73) Assignee: PANASONIC CORPORATION, Osaka (JP)

(21) Appl. No.: 13/006,628

(22) Filed: Jan. 14, 2011

Related U.S. Application Data
(63) Continuation of application No. PCT/JP2009/003233, filed on Jul. 10, 2009.

(30) Foreign Application Priority Data
Jul. 14, 2008 (JP) 2008-183072

(51) Int. Cl. H04N 5/38

(52) U.S. Cl. 348/723; 348/E05.093

(57) ABSTRACT

A video data processing device configured to send video data to a sink device includes: a log generation unit configured to generate log information; a memory configured to receive from the sink device sink device information indicating a format of video which the sink device can display, and store the received sink device information; a log receiving unit configured to receive log information stored in the sink device; a log comparison unit configured to determine whether or not the log information generated in the log generation unit matches the log information stored in the sink device; and a log sending unit configured to send the log information generated in the log generation unit to the sink device. When the log comparison unit determines that both the log information matches, video data is sent to the sink device based on the sink device information in the memory.

This is a continuation of PCT International Application PCT/JP2009/003233 filed on Jul. 10, 2009, which claims priority to Japanese Patent Application No. 2008-183072 filed on Jul. 14, 2008. The disclosures of these applications including the specifications, the drawings, and the claims are hereby incorporated by reference in their entirety.

### BACKGROUND

The present disclosure relates to video data processing devices configured to send or receive video data.

In recent years, high-definition multimedia interfaces (HDMIs) has been used as a standard for transmitting digital video/audio signals. In apparatuses connected to each other via the HDMI, normal operation up to outputting video and the like will be described. An apparatus configured to output video data is referred to as a source device, and an apparatus into which video data is input is referred to as a sink device.

The source device detects a hot plug detect (HPD) signal, and thereafter obtains extended display identification data (EDID) from the sink device. Based on the EDID, the source device recognizes a format of, for example, video/audio information which the sink device can output. The HPD signal indicates whether or not the EDID of the sink device is correctly readable. The maximum size of the EDID in the standard is 128 bytes×256 blocks=32768 bytes, and the EDID is read by Display Data Channel (DDC) communications (e.g., 100 kbps).

Next, the source device outputs a transition minimized differential signaling (TMDS) signal for accessing a high-bandwidth digital content protection (HDCP) register. The source device accesses HDCP information by the DDC communications, obtaining information on the sink device, e.g., on whether or not the sink device supports HDCP. Then, the source device outputs TMDS display signals to the sink device to perform HDCP authentication between the sink and the source using the hitherto obtained information. When the authentication is successful, video/audio is output.

The related technique is disclosed, for example, in Japanese Patent Publication No. 2006-287364.

### SUMMARY

However, since the data size of the EDID is large, it takes time to read the EDID. For this reason, a certain amount of time may be required between the time when the source device starts sending data and the time when the sink device starts outputting video/audio. Moreover, when the sink device does not support the TMDS signal for accessing the HDCP register, the signal may be output as noise.

It is an objective of the present disclosure to shorten the time period until the start of outputting video/audio when video data is sent/received via HDMI.

A video data processing device according to an example of the present invention is a video data processing device configured to send video data to a sink device and including: a log generation unit configured to generate log information; a memory configured to receive from the sink device sink device information indicating a format of video which the sink device can display, and store the received sink device information; a log receiving unit configured to receive log information stored in the sink device; a log comparison unit configured to determine whether or not the log information generated in the log generation unit matches the log information stored in the sink device; and a log sending unit configured to send the log information generated in the log generation unit to the sink device. When the log comparison unit determines that the log information generated in the log generation unit matches the log information stored in the sink device, video data is sent to the sink device based on the sink device information in the memory.

With this configuration, when current log information matches log information stored in the sink device, video data is output to the sink device based on sink device information in the memory, so that it is not necessary to read sink device information from the sink device. Thus, it is possible to shorten the time period until the start of outputting video/audio.

Moreover, a video data processing device according to an example of the present invention is a video data processing device configured to display video represented by video data received from a source device and including: a log sending/receiving unit configured to receive log information sent from the source device; and a storage unit configured to store the log information, wherein the log sending/receiving unit sends the log information stored in the storage to the source device when a start-up sequence is started between the source device and the video data processing device.

With this configuration, when connection to the source device is newly established, log information stored in the storage unit is sent to the source device, so that whether or not current log information matches the log information stored in the storage unit can be determined in the source device.

A video data processing method according to an example of the present invention is a video data processing method for sending video data to a sink device, the video data processing method including: a log generation step of generating log information; a storage step of receiving from the sink device sink device information indicating a format of video which the sink device can display, and storing the received sink device information; a log reception step of receiving log information stored in the sink device; a log comparison step of determining whether or not the log information generated in the log generation step matches the log information stored in the sink device; a step of sending video data to the sink device based on the sink device information when it is determined in the log comparison step that the log information generated in the log generation step matches the log information stored in the sink device; and a log sending step of sending the log information generated in the log generation step to the sink device.

According to the embodiment of the present invention, when video data is sent/received via HDMI, it is possible to shorten the time period until the start of outputting video/audio.

### BRIEF DESCRIPTION OF THE DRAWINGS

FIG. 1 is a block diagram illustrating a configuration of a video data processing system according to an embodiment of the present invention.

FIG. 2 is a flow chart illustrating a start-up sequence in the source device of FIG. 1.

FIG. 3 is a flow chart of the log writing process of FIG. 2.

FIG. 4 is a block diagram illustrating a configuration of a variation of the video data processing system of FIG. 1.

FIG. 5 is a flow chart illustrating a start-up sequence of the source device of FIG. 4.

FIG. 6 is a flow chart illustrating a start-up sequence in the sink device of FIG. 4.

FIG. 7 is a flow chart of the source device information writing process of FIG. 5.

### DETAILED DESCRIPTION

Embodiments of the present invention will be described below with reference to the drawings.

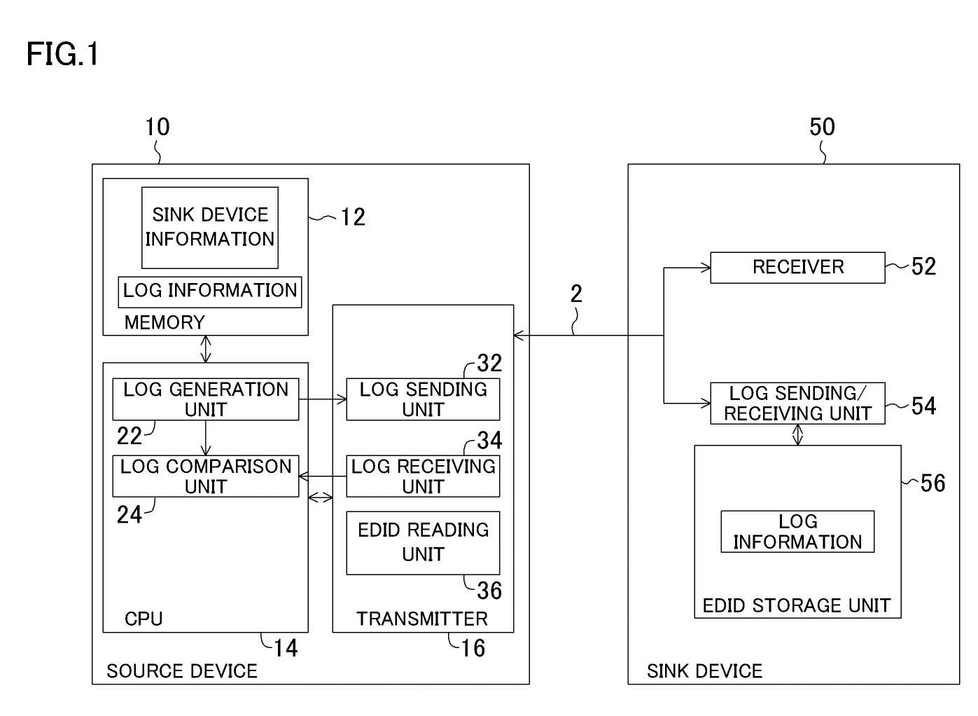

FIG. 1 is a block diagram illustrating a configuration of a video data processing system according to an embodiment of the present invention. The video data processing system of FIG. 1 includes a source device 10 and a sink device 50 which are connected to each other via an HDMI cable 2.

The source device 10 is a video data processing device configured to send video data and audio data to the sink device 50 via HDMI. The source device 10 is, for example, a digital versatile disc (DVD)/hard disk drive (HDD) recorder. The sink device 50 is a video data processing device configured to receive video data and audio data from the source device 10 via HDMI. The sink device 50 is, for example, a digital television receiver. The HDMI cable 2 is defined by the HDMI standard, and includes a DDC communication line which the source device 10 uses to read EDID.

The source device 10 includes a memory 12, a CPU 14, and a transmitter 16. The CPU 14 includes a log generation unit 22, and a log comparison unit 24. The transmitter 16 includes a log sending unit 32, a log receiving unit 34, and an EDID reading unit 36.

The sink device 50 includes a receiver 52, a log sending/receiving unit 54, and an EDID storage unit 56. Moreover, although not illustrated in the figure, the sink device 50 includes a display unit for displaying video, and an audio output unit for outputting audio.

The log generation unit 22 generates, as log information, a number specifying the source device 10. The number is a number by which the source device 10 can be specified, for example, a number unique to the source device 10. After establishment of connection of the source device 10 to the sink device 50, and by the time the connection is terminated, the log sending unit 32 sends the log information generated in the log generation unit 22 to the sink device 50. After establishment of connection of the source device 10 to the sink device 50, and by the time video is displayed, the log receiving unit 34 receives log information stored in the EDID storage unit 56 of the sink device 50. The log information is log information which was sent from the log sending unit 32 to the sink device 50 last time the connection was established.

The memory 12 receives sink device information from the sink device 50, and stores the received sink device information together with the log information generated in the log generation unit 22. The sink device information is information indicating, for example, a format of video which the sink device 50 can display, and includes at least a part of EDID. Until new sink device information is written to the memory 12, the memory 12 stores sink device information received from the sink device 50 last time the connection was established. The log comparison unit 24 compares the log information generated in the log generation unit 22 and stored in the memory 12 with the log information received by the log receiving unit 34 to determine whether or not both of the log information matches. The EDID storage unit 56 stores EDID of the sink device 50. From the EDID storage unit 56, the EDID reading unit 36 reads the EDID of the sink device 50.

After establishment of connection of the source device 10 to the sink device 50, and by the time the connection is terminated, the log sending/receiving unit 54 receives the log information from the log sending unit 32, and sends the log information to the log receiving unit 34. The EDID storage unit 56 stores the log information sent from the log sending unit 32 to the log sending/receiving unit 54.

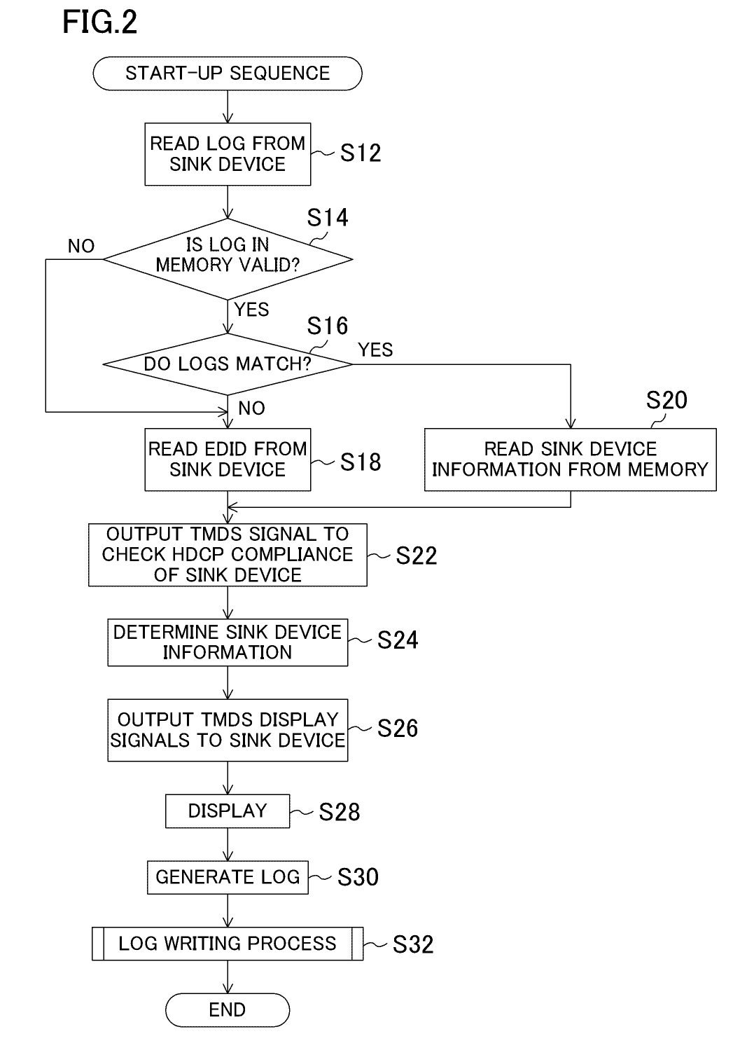

FIG. 2 is a flow chart illustrating a start-up sequence in the source device 10 of FIG. 1. As illustrated in FIG. 2, when the start-up sequence is started between the source device 10 and the sink device 50, in step S12, the log sending/receiving unit 54 of the sink device 50 sends log information stored in the EDID storage unit 56 to the log receiving unit 34 of the source device 10, and the log receiving unit 34 receives the log information, and outputs the received log information to the log comparison unit 24. In step S14, the log comparison unit 24 determines whether or not log information in the memory 12 is valid based on the operation by the log generation unit 22 or based on the log information obtained in step S12. When the log information is valid, the sequence proceeds to step S16, but when the log information is not valid, the sequence proceeds to step S18.

In step S16, the log comparison unit 24 compares the log information obtained in step S12 with the log information in the memory 12. When the log information obtained in step S12 and the log information in the memory 12 matches, the sequence proceeds to step S20, but when the log information obtained in step S12 and the log information in the memory 12 does not match, the sequence proceeds to step S18. In step S18, the EDID reading unit 36 reads EDID from the EDID storage unit 56 of the sink device 50. In step S20, the EDID reading unit 36 does not read the EDID from the sink device 50, but reads sink device information stored in the memory 12.

In step S22, to the sink device 50, the transmitter 16 outputs a TMDS signal to check HDCP compliance for accessing a HDCP register of the sink device 50. In step S24, based on the result of the access to the HDCP register, the transmitter 16 determines whether or not the sink device 50 supports HDCP. The transmitter 16 allows the results of the determination to be included in the sink device information, thereby defining the sink device information. In step S26, the transmitter 16 outputs, based on the sink device information read from the memory 12, data of video which will be displayed by the sink device 50 and of audio which will be output by the sink device 50 by TMDS display signals to the receiver 52.

In step S28, the receiver 52 receives the video data and audio data transmitted by the TMDS signal from the transmitter 16. The sink device 50 starts displaying video represented by the received video data on the display unit and outputting audio represented by the received audio data from the audio output unit. In step S30, the log generation unit 22 generates log information, and stores the generated log information in the memory 12. Moreover, the CPU 14 stores sink device information in the memory 12. The process in this step can be performed after step S24. In step S32, a log writing process is performed.

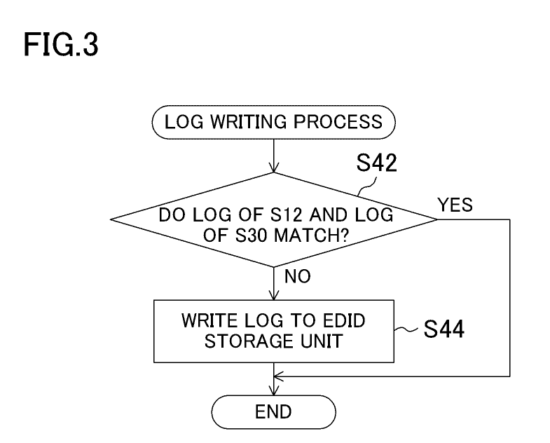

FIG. 3 is a flow chart of the log writing process of FIG. 2. In step S42 of FIG. 3, the log comparison unit 24 compares the log information read in step S12 with the log information generated in step S30. When both the log information matches, the process of FIG. 3 is terminated. When both the log information does not match, the process proceeds to step S44.

In step S44, the log sending unit 32 sends log information to the log sending/receiving unit 54. The log sending/receiving unit 54 receives the log information sent from the log sending unit 32, and writes the received log information to the EDID storage unit 56.

As described above, in the source device 10 and the sink device 50 of FIG. 1, when the log information stored in the source device 10 matches the log information stored in the sink device 50, it is not necessary to read the EDID from the sink device 50. Thus, it is possible to shorten the time period until the start of outputting video/audio.

Note that in step S44, the log generation unit 22 may generate, as log information, the sum of some or all of numbers contained in the EDID of the sink device 50. In this case, in step S44, the log generation unit 22 allows the generated log information to be sent to the log sending/receiving unit 54 and to be stored in the memory 12.

The log information which will be sent to the log sending/receiving unit 54 may be stored in the memory 12. In this case, the log generation unit 22 may generate any number as log information.

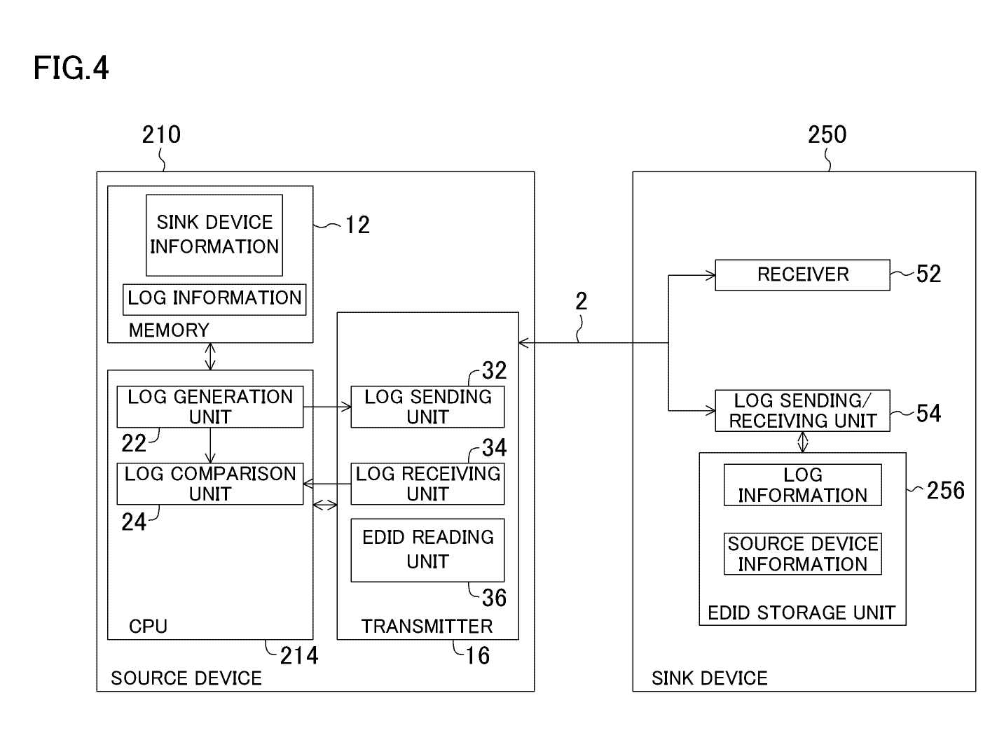

FIG. 4 is a block diagram illustrating a configuration of a variation of the video data processing system of FIG. 1. The video data processing system of FIG. 4 is different from the video data processing system of FIG. 1 in that a source device 210 and a sink device 250 is provided instead of the source device 10 and the sink device 50, respectively. The source device 210 is different from the source device 10 in that a CPU 214 is provided instead of the CPU 14. The sink device 250 is different from the sink device 50 in that an EDID storage unit 256 configured to store source device information is provided instead of the EDID storage unit 56.

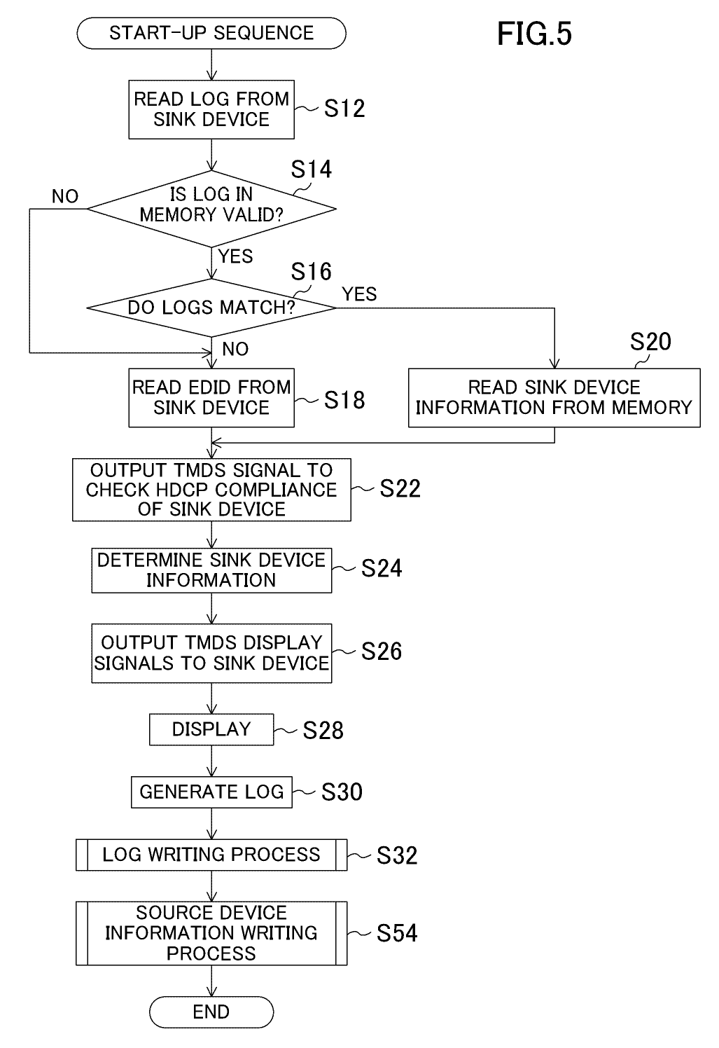

FIG. 5 is a flow chart illustrating a start-up sequence in the source device 210 of FIG. 4. The flow chart of FIG. 5 is the same as the flow chart of FIG. 2 except that step S24 is performed after step S20, and that the flow chart of FIG. 5 includes source device information writing process step S54.

The process in step S20 is performed when the sink device 250 (which has connected to the source device 210 previously) is connected to the source device 210 again, or when the start-up sequence between the source device 210 and the sink device 250 is performed again. In this case, since it has already confirmed that the sink device 250 supports HDCP, the process in step S22 is not performed. The transmitter 16 does not output to the sink device 50 the TMDS signal to check HDCP compliance for accessing the HDCP register of the sink device 50, so that it is possible to prevent the TMDS signal from being output as noise.

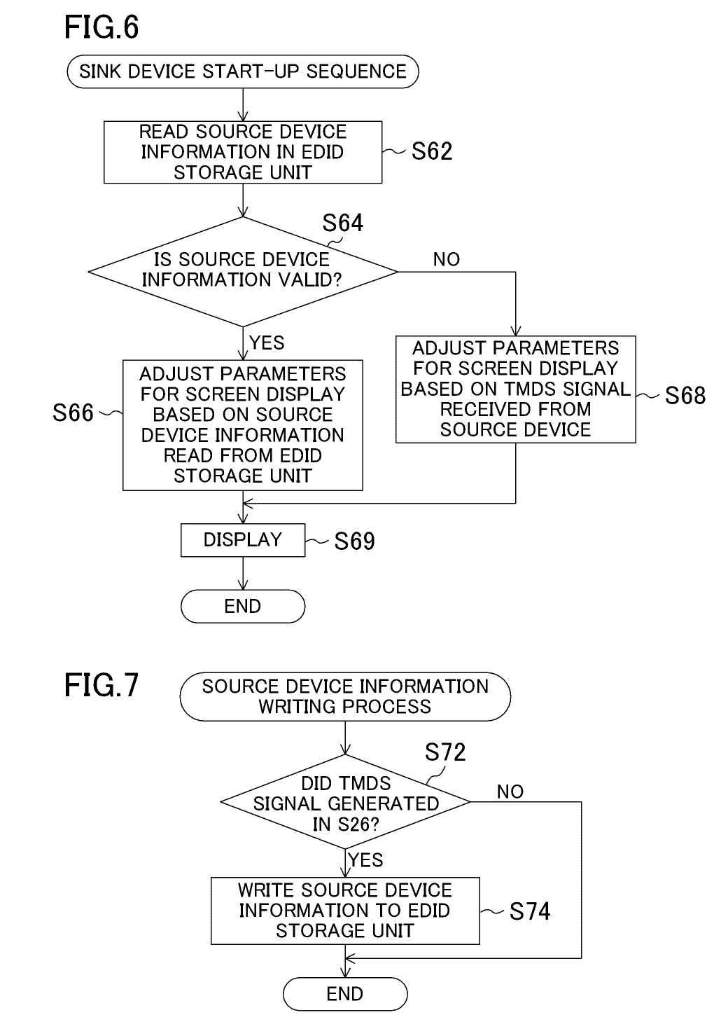

FIG. 6 is a flow chart illustrating a start-up sequence in the sink device 250 of FIG. 4. When the TMDS signal output in step S22 of FIG. 5 is different from the TMDS signal output in step S26, the TMDS signals are switched, and at the time of the switching, noise may be output. Then, the sink device 250 adjusts parameters for screen display, and parameters for audio output in the start-up sequence of FIG. 6 so that these TMDS signals are the same signal.

In step S62 of FIG. 6, the sink device 250 reads source device information from the EDID storage unit 256. The source device information includes information indicating for example, a format of video sent from a source device which has been connected to the sink device 250 previously. In step S64, the sink device 250 determines whether or not the source device information read from the EDID storage unit 256 is valid, i.e., whether or not the source device information at the time of the previous connection to the source device 210 was read. When the source device information of the previous connection was read, the sequence proceeds to step S66, but when the source device information of the previous connection was not read, the sequence proceeds to step S68.

In step S66, the sink device 250 adjusts parameters for screen display, and parameters for audio output based on the source device information read from the EDID storage unit 256. In step S68, the sink device 250 receives source device information from the source device 210 by the TMDS signal, based on which screen display parameters and audio output parameters are adjusted. In step S69, the sink device 250 displays video received by the TMDS signal.

FIG. 7 is a flow chart of a source device information writing process of FIG. 5. In step S72 of FIG. 7, the CPU 214 determines whether or not the TMDS signal was generated in step S26 of FIG. 5. When the TMDS signal was generated, the process proceeds to step S74, but when the TMDS signal was not generated, the source device information writing process is terminated. In step S74, the log sending/receiving unit 54 writes the source device information received from the source device 210 to the EDID storage unit 256.

As described above, when the source device information read from the EDID storage unit 256 is valid, the sink device 250 adjusts screen display parameters, and the like based on the read source device information without using the TMDS signal received from the source device 210. Thus, it is possible not only to shorten the time period until the start of displaying on a screen and outputting audio, but also to prevent noise due to switching the TMDS signals from being output.

As described above, according to the embodiment of the present invention, it is possible to shorten the time period until the start of outputting video/audio, so that the present invention is useful for video data processing devices, and the like.

What is claimed is:

1. A video data processing device configured to send video data to a sink device, the video data processing device comprising:
a log generation unit configured to generate log information;
a memory configured to receive from the sink device sink device information indicating a format of video which the sink device can display, and store the received sink device information;
a log receiving unit configured to receive log information stored in the sink device;
a log comparison unit configured to determine whether or not the log information generated in the log generation unit matches the log information stored in the sink device; and
a log sending unit configured to send the log information generated in the log generation unit to the sink device, wherein
when the log comparison unit determines that the log information generated in the log generation unit matches the log information stored in the sink device, video data is sent to the sink device based on the sink device information in the memory.

2. The video data processing device of claim 1, wherein
the log generation unit generates, as the log information, a number unique to the video data processing device.

3. The video data processing device claim 1, wherein
the log generation unit generates, as the log information, the sum of some or all of numbers included in extended display identification data (EDID) of the sink device.

4. A video data processing device configured to display video represented by video data received from a source device, the video data processing device comprising:
a log sending/receiving unit configured to receive log information sent from the source device; and
a storage unit configured to store the log information, wherein
the log sending/receiving unit sends the log information stored in the storage to the source device when a start-up sequence is started between the source device and the video data processing device.

5. The video data processing device of claim 4, wherein
the storage unit stores source device information indicating a format of video sent from the source device, and
when source device information at the time of previous connection to the source device is read from the storage, the video data processing device adjusts parameters for screen display based on the source device information at the time of the previous connection to the source device.

6. A video data processing method for sending video data to a sink device, comprising:
a log generation step of generating log information;
a storage step of receiving from the sink device sink device information indicating a format of video which the sink device can display, and storing the received sink device information;
a log reception step of receiving log information stored in the sink device;
a log comparison step of determining whether or not the log information generated in the log generation step matches the log information stored in the sink device;
a step of sending video data to the sink device based on the sink device information when it is determined in the log comparison step that the log information generated in the log generation step matches the log information stored in the sink device; and
a log sending step of sending the log information generated in the log generation step to the sink device.
